(19) United States
(12) Patent Application Publication
(10) Pub. No.: US 2017/0120910 A1
(43) Pub. Date: May 4, 2017

(54) METHOD FOR OPERATING A LONGITUDINAL CONTROL DEVICE OF A MOTOR VEHICLE IN A TRAFFIC CIRCLE

(71) Applicant: Robert Bosch GmbH, Stuttgart (DE)

(72) Inventors: Michael SCHUBERT, Althengstett (DE); Karsten Georg, Leonberg (DE); Matthias-Bastian Brenner, Leinfelden-Echterdingen (DE); Benjamin Federschmid, Neuhausen (DE)

(21) Appl. No.: 15/335,746

(22) Filed: Oct. 27, 2016

(30) Foreign Application Priority Data
Nov. 3, 2015 (DE) 10 2015 221 452.4
Dec. 30, 2015 (DE) 10 2015 226 840.3

(51) Int. Cl. B60W 30/14

(52) U.S. Cl. CPC B60W 30/143; B60W 2540/18; B60W 2520/14; B60W 2520/10; B60W 2720/106; B60W 2400/00

(57) ABSTRACT

A method for operating a longitudinal control device of a motor vehicle in a traffic circle, includes: locating the motor vehicle in the traffic circle; substantially maintaining a constant speed of the motor vehicle between entering the traffic circle and turning to exit the traffic circle; and precisely accelerating the motor vehicle while exiting the traffic circle.

### RELATED APPLICATION INFORMATION

The present application claims priority to and the benefit of German patent application no. 10 2015 221 452.4, which was filed in Germany on Nov. 3, 2015, and German patent application no. 10 2015 226 840.3, which was filed in Germany on Dec. 30, 2015, the disclosure of both of which are incorporated herein by reference.

### FIELD OF THE INVENTION

The present invention relates to a method for operating a longitudinal control device of a motor vehicle in a traffic circle. The present invention further relates to a longitudinal control device for a motor vehicle.

### BACKGROUND INFORMATION

One proximity control system (adaptive cruise control, ACC) is an automotive assistance system for implementing semi-automatic travel operation of the motor vehicle, including a longitudinal controller and an optional lateral controller and, if indicated, further control elements. Desired parameters for such a system, such as a desired speed or a desired distance from a leading vehicle, are inputted, e.g., using an adjustment lever in the motor vehicle.

The driver may be relieved of simple driving tasks by the above-mentioned ACC system. The system follows the vehicle in front, up to a set, desired speed. Without a vehicle driving in front, the system automatically adjusts the desired speed set by the driver. In order to ensure comfortable handling in curves, as well, the maximum transverse acceleration is limited by adjusting the speed moderately. To that end, a maximum possible speed of the motor vehicle for a curve may be determined from driving dynamics data (e.g., yaw rate, steering angle, etc.) and navigation data, the maximum possible speed then being adjusted to an actual vehicle speed with the aid of a suitable control strategy.

As a rule, the conventional control system in curves, as in the related art, may function highly effectively in curves in all speed ranges, as well as in turning-off events.

### SUMMARY OF THE INVENTION

An object of the present invention is to provide an improved longitudinal control device for a motor vehicle.

According to a first aspect, the object is achieved by a method for operating a longitudinal control device of a motor vehicle in a traffic circle, including the steps:
locating the motor vehicle in the traffic circle;
substantially maintaining a constant speed of the motor vehicle between entering the traffic circle and turning to exit the traffic circle; and
precisely accelerating the motor vehicle while exiting the traffic circle.

In this manner, a performance of the motor vehicle is achieved, which substantially simulates a human behavior of driving a motor vehicle in a traffic circle, which means that a comfort level of operating the motor vehicle is advantageously increased.

According to a second aspect, the object is achieved by a longitudinal control device for a motor vehicle, including:
a locating device, by which it is feasible to locate the motor vehicle in a traffic circle; and
a control device, with the aid of which a speed of the motor vehicle between entering the traffic circle and turning to exit the traffic circle may be kept substantially constant; a precise acceleration for the motor vehicle being able to be generated while exiting the traffic circle.

Advantageous further refinements of the method are subject matter of dependent claims.

One advantageous further refinement of the method provides for the motor vehicle to be located in the traffic circle with the aid of digital map data. This advantageously assists in providing a high locating accuracy of the motor vehicle, which means that the method is implemented particularly efficiently and in a user-friendly manner for the driver.

A further advantageous refinement of the method provides that the motor vehicle be located in the traffic circle by evaluating acquired sensor data of the motor vehicle. In this manner, digital map data are actually not available, but in this case, as well, an acceleration of the motor vehicle is increased precisely upon exiting the traffic circle, through which travel comfort may be increased considerably.

A further advantageous refinement of the method provides for the sensor data to relate to at least one of the following: steering angle of the motor vehicle, yaw rate of the motor vehicle, speed of the motor vehicle. In this manner, parameters of the operation of the motor vehicle may be used for locating in the traffic circle. Using a sensor system that is, as a rule, already at hand, this is advantageously possible without additional engineering expenditure.

A further advantageous refinement of the method provides for a direction of traffic to be detected, the method being performed in accordance with the detected direction of traffic. In this manner, it is advantageously possible for the method to function in the case of driving on both the left and right. Such a design is advantageously possible with the aid of simple software adjustments, in particular, setting the algebraic sign of algorithms.

In the following, the present invention is described in detail with further features and advantages, using several figures. In this context, all features described or represented form, individually or in any combination, the subject matter of the present invention, regardless of their combination as described herein or their antecedent reference, as well as independently of their wording and representation in the description and in the figures, respectively. Above all, the figures are meant to clarify the principles essential to the present invention.

Revealed features of the method follow analogously from corresponding, revealed features of the device, and vice versa. This means, in particular, that features, technological advantages and variants relating to the method for operating a longitudinal control device of a motor vehicle follow analogously from corresponding variants, features and advantages relating to the longitudinal control device, and vice versa.

### BRIEF DESCRIPTION OF THE DRAWINGS

FIG. 1 basic time characteristics of conventional accelerations of a motor vehicle in a traffic circle.

FIG. 2 basic time characteristics of accelerations of a motor vehicle in a traffic circle.

FIG. 3 a basic flow chart of a specific embodiment of the method according to the present invention.

FIG. 4 a schematic of a longitudinal control device for a motor vehicle, according to the present invention.

### DETAILED DESCRIPTION

As explained above, conventional control systems in curves, may function highly effectively in curves in all speed ranges, as well as in turning-off events. However, traffic circles can be problematic, the navigation of a traffic circle including the following phases P1 to P5:

P1 driving into the traffic circle (in the case of driving on the right: right-hand curve)

P2 turning (in the case of driving on the right side, turning from a right-hand curve into a left-hand curve)

P3 driving in the traffic circle (in the case of driving on the right: left-hand curve)

P4 turning (in the case of driving on the right side, turning from a left-hand curve into a right-hand curve)

P5 driving out of the traffic circle (in the case of driving on the right: right-hand curve)

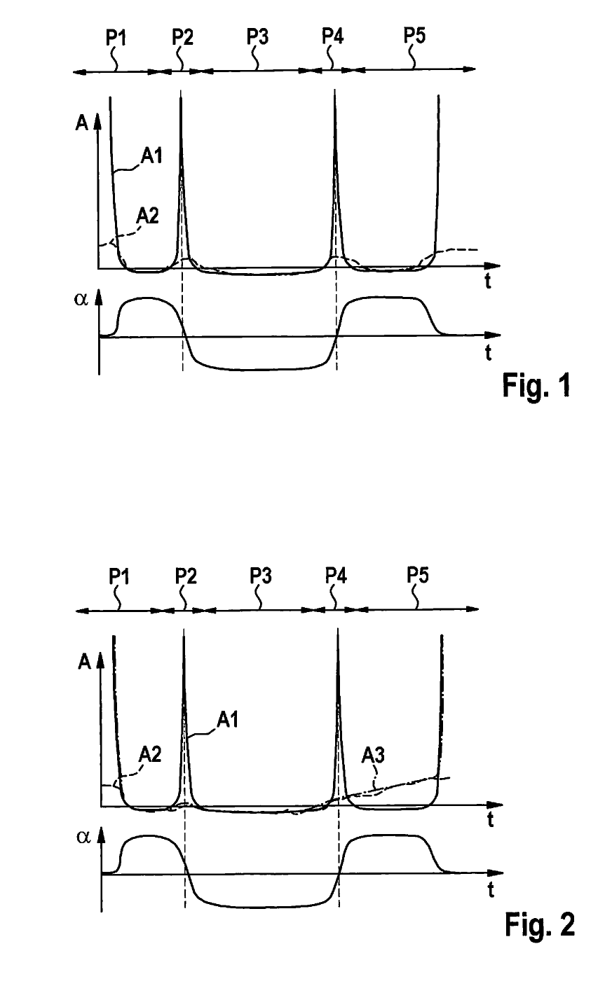

A characteristic curve of a desired acceleration A1 versus time t in the above-mentioned five phases P1 . . . P5 of the traffic circle is represented, in principle, in FIG. 1. A characteristic curve of an actual acceleration A2 versus time t in phases P1 . . . P5 of the traffic circle is also represented in the figure, the actual acceleration A2 including lags and various control inaccuracies of a longitudinal control device (not shown).

A steering angle a of the motor vehicle versus time t is shown in a lower section of FIG. 1.

It is apparent that in phases P1, P3 and P5, a transverse acceleration of the motor vehicle is adjusted by limiting a vehicle speed. Since the steering system briefly has a low steering angle, that is, defines an instance of straight-ahead driving, in phases P2 and P4, the motor vehicle is normally accelerated in these phases P2, P4. Consequently, a trip in a traffic circle, using a conventional, active ACC system, is characterized by unpleasant, jerky transitions between the decelerations in phases P1, P3 and P5 and the accelerations in phases P2 and P4.

The implementation of an improved, comfortable operational performance of a longitudinal control device of a motor vehicle, in particular, in traffic circles, is provided.

Using the provided method, a motor vehicle is put into the position of being able to travel comfortably through a traffic circle, using an activated ACC system. The characteristic curve of a desired acceleration A3 (“desired acceleration using traffic circle logic”) represented, in principle, in FIG. 2 is regarded as particularly comfortable and adapted to a typical human driving behavior.

In addition to the conventional characteristic curve of desired acceleration A1, FIG. 2 shows, in principle, that a specific embodiment of the proposed method affects a desired acceleration A3 over time t as described below:

It is apparent that in phase P1, the speed of the motor vehicle is limited.

In phase P2, unlike in conventional systems, there is no acceleration; instead, the speed of the motor vehicle is held substantially constant.

In phase P3, the speed of the motor vehicle is limited or held constant, so that as a result, in phases P2 and P3, that is, during the complete trip in the traffic circle, the speed of the motor vehicle is held substantially constant.

In phase P4, the motor vehicle is accelerated precisely.

In phase P5, unlike in conventional systems, the speed of the motor vehicle is not reduced, but at least maintained or moderately accelerated. Therefore, as a result, the motor vehicle is moderately accelerated during the moment of turning to drive out of the traffic circle and during the drive out of the traffic circle.

A characteristic curve of an actual acceleration A2, which represents a characteristic curve of desired acceleration A3 with control-system inaccuracies and lags of the system, is also shown in FIG. 2.

The present invention is elucidated below, using exemplary numerical values. However, it is clear that other defined numerical values are also possible for producing the proposed operating characteristic of the longitudinal control device. What is assumed, is a traffic circle that may be traversed by a motor vehicle continuously at 25 km/h in a comfortable manner. In addition, an entering speed of the motor vehicle into the traffic circle of app. 30 km/h is assumed.

According to the related art, the speed of the motor vehicle is limited to app. 25 km/h upon entering the traffic circle (phase P1).

Upon turning (phase P2), the motor vehicle is accelerated again to 30 km/h. Subsequently, the speed of the motor vehicle is limited to app. 25 km/h while traveling in the traffic circle (phase P3). Short-term acceleration to app. 30 km/h again is carried out for the exiting (Phase P4), before deceleration to 25 km/h again is carried out while exiting; after that, acceleration to the desired speed is finally carried out again (phase P5).

Upon entering the traffic circle (phase P1), the speed of the motor vehicle is reduced to 25 km/h. This is maintained during the complete trip in the circle (phases P2 and P3). The vehicle accelerates upon changing direction for turning off (phase P4), and during the turning-off itself (phase P5), deceleration is not carried out again.

How the longitudinal control device of the present invention differs from the conventional longitudinal control device, is readily discernible from FIG. 2:

Namely, from FIG. 2, one can recognize that in phases P2 and P5, in which the proposed characteristic curve does not correspond to the conventional characteristic curve of the desired acceleration, the operating characteristic of longitudinal control device 100 is adapted by modifying the desired acceleration.

In one specific embodiment, the beginning of phase P1 and the end of phase P5 are communicated by a navigation system, that is, using digital map data of longitudinal control device 100. It may be sufficient for the digital map data to be present in the vehicle in some manner and to be transmitted to the vehicle, for example, via an external data connection. In this manner, transitions between individual phases P1 . . . P5 may be derived in view of the monitoring of the operating dynamics variables (e.g., yaw rate and steering angle).

In a further variant, it is also advantageously possible to detect a direction of traffic and to execute the proposed method in accordance with the direction of traffic. In this manner, the method is advantageously applicable both in the case of driving on the right and in the case of driving on the left.

In one alternative, it is also advantageously possible to execute the method completely without digital map material, only entry into the traffic circle and a geometric position inside of the traffic circle being detected by the vehicle sensor system. This may be the case, for example, in a system not having use of navigation, the trip in the traffic circle being recognized exclusively in light of the operating dynamics variables, as well as, optionally, on the basis of manipulation of the blinker upon driving out. However, in this case, a specific reaction of longitudinal control device 100 is only possible in phase P5, since in preceding phases P1 . . . P4, a traffic circle may not be assumed with sufficient certainty without digital map material. Consequently, in this case, the specific characteristic of longitudinal control device 100 is not applicable in phase 2.

Nevertheless, in this variant, a marked improvement over conventional systems is also noticeable, since in most cases, phase P5 plays a decisive role in the travel comfort.

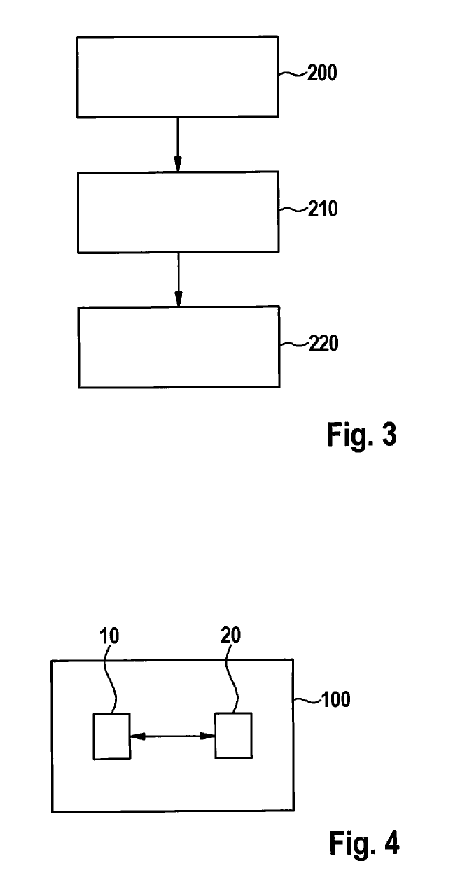

FIG. 3 shows a basic flow chart of a specific embodiment of the method according to the present invention.

In a step 200, the motor vehicle is located in the traffic circle.

In a step 210, a constant speed of the motor vehicle is substantially maintained between entering the traffic circle and turning to exit the traffic circle.

In a step 220, the motor vehicle is accelerated precisely while traveling out of the traffic circle.

The method may be implemented in the form of software.

In this manner, updating and modification are advantageously simplified.

FIG. 4 shows a highly simplified schematic block diagram of a specific embodiment of longitudinal control device 100.

One recognizes a locating device 10 and a control device 20, which interact functionally in such a manner and are formed in such a manner, that the operating characteristic of longitudinal control device 100 described below may be generated.

In summary, the present invention provides a method for an improved, more comfortable operation of a longitudinal control device of a motor vehicle in a traffic circle.

One skilled in the art will modify the features of the present invention in a suitable manner and/or combine them with one another without departing from the essence of the present invention.

What is claimed is:

1. A method for operating a longitudinal control device of a motor vehicle in a traffic circle, the method comprising:
locating the motor vehicle in the traffic circle;
substantially maintaining a constant speed of the motor vehicle between entering the traffic circle and turning to exit the traffic circle; and
precisely accelerating the motor vehicle while exiting the traffic circle.

2. The method of claim 1, wherein the motor vehicle is located in the traffic circle, using digital map data.

3. The method of claim 1, wherein the motor vehicle is located in the traffic circle by evaluating acquired sensor data of the motor vehicle.

4. The method of claim 3, wherein the sensor data relate to at least one of the following: steering angle of the motor vehicle, yaw rate of the motor vehicle, speed of the motor vehicle.

5. The method of claim 1, wherein a direction of traffic is detected, and the method is performed in accordance with the detected direction of traffic.

6. A longitudinal control device for a motor vehicle, comprising:
a locating device to locate the motor vehicle in a traffic circle; and
a control device by which a speed of the motor vehicle between entering the traffic circle and turning to exit the traffic circle may be kept substantially constant;
wherein a precise acceleration for the motor vehicle being able to be generated while exiting the traffic circle.

7. The longitudinal control device of claim 6, wherein the locating device receives map data from digital map data.

8. The longitudinal control device of claim 6, wherein the locating device receives evaluated sensor data of the motor vehicle.

9. An ACC control device for a motor vehicle, comprising:
longitudinal control device for a motor vehicle, including:
a locating device to locate the motor vehicle in a traffic circle; and
a control device by which a speed of the motor vehicle between entering the traffic circle and turning to exit the traffic circle may be kept substantially constant;
wherein a precise acceleration for the motor vehicle being able to be generated while exiting the traffic circle.

10. A computer readable medium having a computer program, which is executable by a processor, comprising:
a program code arrangement having program code for operating a longitudinal control device of a motor vehicle in a traffic circle, by performing the following:
locating the motor vehicle in the traffic circle;
substantially maintaining a constant speed of the motor vehicle between entering the traffic circle and turning to exit the traffic circle; and
precisely accelerating the motor vehicle while exiting the traffic circle.
